(19) United States
(12) Patent Application Publication
(10) Pub. No.: US 2021/0392349 A1
(43) Pub. Date: Dec. 16, 2021

(54) Adaptive Resolution Video Coding

(71) Applicant: Alibaba Group Holding Limited, Grand Cayman (KY)

(72) Inventors: Tsuishan Chang, Hangzhou (CN); Yu-Chen Sun, Bellevue, WA (US); Ling Zhu, Hangzhou (CN); Jian Lou, Bellevue, WA (US)

(21) Appl. No.: 17/257,527

(22) PCT Filed: Mar. 1, 2019
(86) PCT No.: PCT/CN2019/076701

§ 371 Date: Dec. 31, 2020

(51) Int. Cl. H04N 19/30; H04N 19/105; H04N 19/423; H04N 19/169; H04N 19/176

(52) U.S. Cl. CPC H04N 19/30; H04N 19/105; H04N 19/176; H04N 19/188; H04N 19/423

(57) ABSTRACT

A client device may receive encoded data of a first video frame from a server over a network, and decode the encoded data to obtain the first frame based at least in part on one or more second frames of a second resolution that are stored in a reference frame buffer of the client device. In response to determining that the first resolution is lower than the second resolution, the client device may or may not resize the first frame from the first resolution to the second resolution and store the first frame of the first resolution and/or the resized first frame of the second resolution in the reference frame buffer, depending on which coding design that the client device employs. The client device may display the reconstructed frame to a user.

### BACKGROUND

With the development of the Internet, video streaming applications have become very popular in daily lives of people. A user can now watch a video using a video streaming application without waiting for a complete download of an entire file (which can be a few megabytes to a few gigabytes in size) of the video, which could take a few minutes to a few tens of minutes. Currently, conventional video codec, such as H.264/AVC, H.265/HEVC, etc., is employed to stream a video from a video source to a client device of a user who watches the video over a network.

In view of network instability and variations in the amount of traffic in a network, it is desirable to encode and transmit a video, e.g., frames (e.g., inter-coded frames) of a video sequence, at different resolutions adaptively in real time according to certain attributes of the network, such as network bandwidth. However, the conventional video codec (e.g., H.264/AVC and H.265/HEVC) requires frames in the same video sequence to have the same frame size or resolution because the frame size is recorded in a sequence level header of the video sequence and cannot be changed in inter-coded frames. Accordingly, if the frame size or resolution of the frames needs to be changed, a new video sequence needs to be started, and an intra-coded frame needs to be encoded, compressed, and transmitted first. However, encoding, compressing and transmitting an intra-coded frame unavoidably add extra time, computational effort and network bandwidth, causing the change of video resolution adaptively according to network conditions using the conventional video codec to be difficult and expensive.

A new frame type, namely, a switch frame, is currently proposed in AVI codec, and is used as a transition frame to switch between video sequences of different frame sizes or resolutions. While avoiding the use of intra coding and thus the cost of a full intra-coded frame, this type of switch frame still requires extra computational time/effort and network bandwidth as compared with that of a normal inter-coded frame, and hence introduces an overhead in term of computational time/effort and network bandwidth when a video resolution is changed. Furthermore, under this proposed approach of using a switch frame, a motion vector coding of a current frame cannot use motion vectors in previous frames as motion vector predictors.

A next generation video codec, H.266/VVC, is currently under development, and a number of new coding tools are proposed in H.266/VVC. In order to support resolution changes in inter-coded frames, new coding system designs are required for situations in which frame sizes or resolutions are not consistent in a same video sequence.

### SUMMARY

This summary introduces simplified concepts of adaptive resolution video coding, which will be further described below in the Detailed Description. This summary is not intended to identify essential features of the claimed subject matter, nor is it intended for use in limiting the scope of the claimed subject matter.

This application describes example implementations of adaptive resolution video coding. In implementations, a first computing device may adaptively encode video frames (e.g., inter-coded frames) of different resolutions in a same video sequence, and transmit the frames to a second computing device over a network. In implementations, the first computing device may further signal a maximal resolution in a sequence header of the video sequence, and signal a relative resolution of each frame in a frame header of the respective frame.

In implementations, the second computing device may receive encoded data of a first video frame from the first computing device over the network, and decode the encoded data to obtain the first frame based at least in part on one or more second frames of a second resolution that are stored in a reference frame buffer of the second computing device. In implementations, in response to determining that the first resolution is lower than the second resolution, the second computing device may or may not resize the first frame from the first resolution to the second resolution and store the first frame of the first resolution and/or the resized first frame of the second resolution in the reference frame buffer, depending on which coding design that the second computing device employs.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment in which an adaptive resolution video coding system may be used.

FIG. 2 illustrates an example encoding system in more detail.

FIG. 3 illustrates an example decoding system in more detail.

FIG. 4 illustrates an example method of adaptive video encoding.

FIG. 5 illustrates an example method of adaptive video decoding.

### DETAILED DESCRIPTION

### Overview

As noted above, existing technologies require either starting a new video sequence or introducing a new frame type in order to change resolutions of video frames in a video sequence, which incurs additional time and computational cost, and fails to flexibly adjust resolutions of video frames (e.g., inter-coded frames) of a video sequence in real time based on network conditions.

This disclosure describes an example adaptive resolution video coding system. The adaptive resolution video coding system may include an adaptive encoding system and an adaptive decoding system. The adaptive encoding system and the adaptive decoding system may operate individually and/or independently from each other on two points of a network, and are related with each other because of a video sequence that is transmitted therebetween under an agreed-upon coding protocol or standard.

In implementations, the adaptive encoding system may determine a first resolution or frame size of a first frame of a video sequence based on network conditions (e.g., network bandwidth), and encode the first frame of the first resolution in real time based on one or more second frames of the same video sequence that have been previously transmitted using inter-coding, for example. Depending on the network conditions, the first resolution or frame size may or may not be the same as a second resolution or frame size of the one or more second frames. In implementations, the adaptive encoding system may signal information of the first resolution in a frame header of the first frame, and may additionally signal a maximal resolution for the video sequence in a sequence header of the video sequence. Upon obtaining encoded data of the first frame, the adaptive encoding system may transmit the encoded data of the first frame to the adaptive decoding system via a network.

In implementations, the adaptive decoding system may receive the encoded data of the first frame from the adaptive encoding system through the network. The adaptive decoding system may decode the encoded data to reconstruct the first frame based on the one or more second frames that are received and locally stored in a reference frame buffer prior to sending the encoded data of the first frame. In implementations, if the first resolution or frame size of the first frame is not the same as the second resolution or frame size of the one or more second frames, the adaptive decoding system may resize motion predictors and/or rescale motion vectors associated with the one or more second frames, or resize the one or more second frames into the first resolution or frame size. The adaptive decoding system may then decode the encoded data to reconstruct the first frame based on the resized motion predictors and/or rescaled motion vectors, or the one or more resized second frames. The adaptive decoding system may provide the first frame of the first resolution or the second resolution to a display for presentation.

Furthermore, depending on which decoding design that the adaptive decoding system employs, the adaptive decoding system may resize (e.g., up-sample) the first frame from the first resolution to the second resolution, and store the first frame of the first resolution and/or the resized first frame of the second resolution into the reference frame buffer for use by subsequent frames of the video sequence.

In the examples described herein, the described adaptive resolution video coding system allows adaptive changes of resolution or frame size of individual frames in a video sequence at any time in real time without the need of starting a new video sequence or using a new frame type, thus avoiding unnecessary introduction of additional time and computational cost caused by starting the new video sequence or using the new frame type.

Furthermore, functions described herein to be performed by the adaptive video encoding system and/or the adaptive decoding system may be performed by multiple separate units or services. For example, for the adaptive video encoding system, a determination service may determine a first resolution or frame size of a first frame of a video sequence based on network conditions, while an encoding service may encode the first frame of the first resolution in real time based on one or more second frames of the same video sequence that have been previously transmitted using inter-coding. A signaling service may signal information of the first resolution in a frame header of the first frame, and signal a maximal resolution for the video sequence in a sequence header of the video sequence, while yet another service may transmit the encoded data of the first frame to the adaptive decoding system via a network.

Moreover, although in the examples described herein, any one of the adaptive video encoding system and the adaptive decoding system may be implemented as software and/or hardware installed in a single device, in other examples, any one of the adaptive video encoding system and the adaptive decoding system may be implemented and distributed in multiple devices or as services provided in one or more servers over a network and/or in a cloud computing architecture.

The application describes multiple and varied implementations and implementations. The following section describes an example framework that is suitable for practicing various implementations. Next, the application describes example systems, devices, and processes for implementing an adaptive resolution video coding system.

### Example Environment

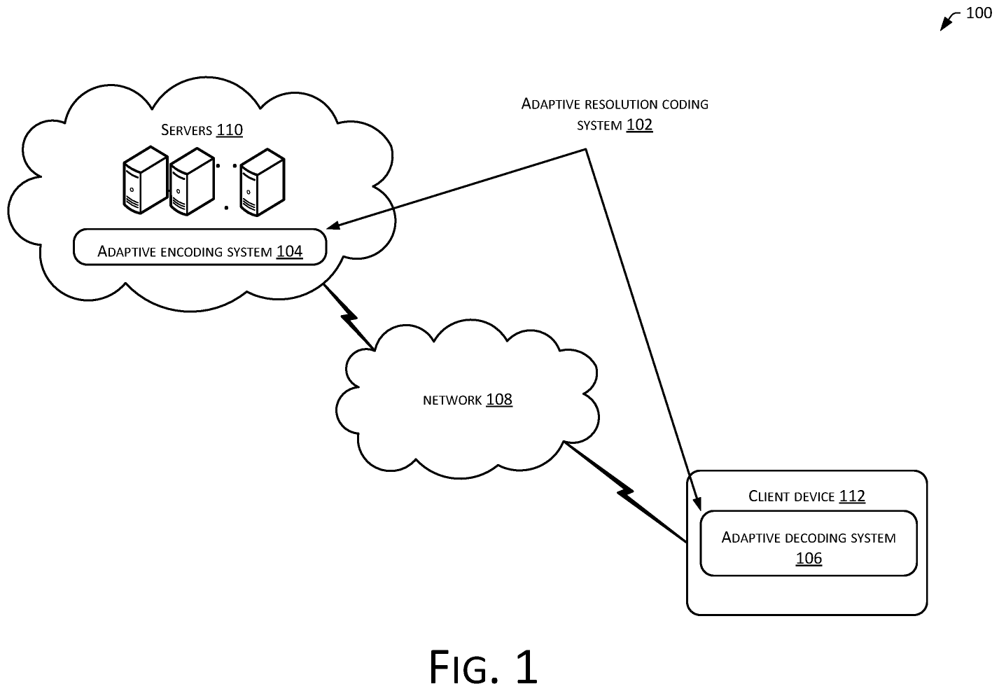

FIG. 1 illustrates an example environment 100 usable to implement an adaptive resolution video coding system. The environment 100 may include an adaptive resolution video coding system 102. In this example, the adaptive resolution video coding system 102 is described to include an adaptive encoding system 104 and an adaptive decoding system 106. In other instances, the adaptive resolution video coding system 102 may include one or more adaptive encoding systems 104 and/or one or more adaptive decoding systems 106. The adaptive encoding system 104 and the adaptive decoding system 106 can operate independently from each other, and are related as being sending and receiving parties of a video sequence respectively. In implementations, the adaptive encoding system 104 communicates data with the adaptive decoding system 106 through a network 108.

In implementations, the adaptive encoding system 104 may include one or more servers 110. In some instances, the adaptive encoding system 104 may be part of the one or more servers 110, or may be included in and/or distributed among the one or more servers 110, which may communicate data with one another and/or with the adaptive decoding system 106 via the network 108. Additionally or alternatively, in some instances, the functions of the adaptive encoding system 104 may be included in and/or distributed among the one or more servers 110. For example, a first server of the one or more servers 110 may include part of the functions of the adaptive encoding system 104, while other functions of the adaptive encoding system 104 may be included in a second server of the one or more servers 110. Furthermore, in some embodiments, some or all the functions of the adaptive encoding system 104 may be included in a cloud computing system or architecture, and may be provided as services that can be requested by the adaptive decoding system 106.

In implementations, the adaptive decoding system 106 may be part of the client device 112, e.g., software and/or hardware components of the client device 112. In some instances, the adaptive decoding system 106 may include a client device 112.

The client device 112 may be implemented as any of a variety of computing devices including, but not limited to, a desktop computer, a notebook or portable computer, a handheld device, a netbook, an Internet appliance, a tablet or slate computer, a mobile device (e.g., a mobile phone, a personal digital assistant, a smart phone, etc.), etc., or a combination thereof.

The network 108 may be a wireless or a wired network, or a combination thereof. The network 108 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. Wired networks may include an electrical carrier connection (such a communication cable, etc.) and/or an optical carrier or connection (such as an optical fiber connection, etc.). Wireless networks may include, for example, a WiFi network, other radio frequency networks (e.g., Bluetooth®, Zigbee, etc.), etc.

In implementations, a user may want to watch a video using a browser or a video streaming application provided by the client device 112. In response to receiving a command from the user, the browser or video streaming application may request the video from the one or more servers 110 associated with the adaptive encoding system 104, and relay encoded data of video frames of a video sequence received from the one or more servers 110 (or the adaptive encoding system 104) to the adaptive decoding system 106 for decoding and reconstructing the video frames for presentation in a display of the client device 112.

### Example Adaptive Encoding System

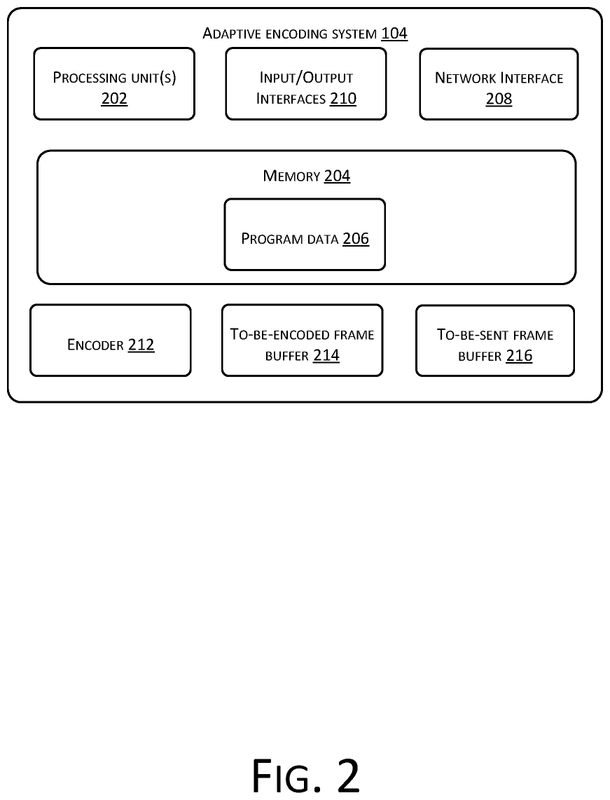

FIG. 2 illustrates the adaptive encoding coding system 104 in more detail. In implementations, the adaptive encoding system 104 may include, but is not limited to, one or more processing units 202, memory 204, and program data 206. In implementations, the adaptive encoding system 104 may further include a network interface 208 and an input/output interface 210. Additionally or alternatively, some or all of the functionalities of the adaptive encoding system 104 may be implemented using an ASIC (i.e., Application-Specific Integrated Circuit), a FPGA (i.e., Field-Programmable Gate Array), or other hardware provided in the adaptive encoding system 104.

In implementations, the one or more processing units 202 are configured to execute instructions received from the network interface 208, received from the input/output interface 210, and/or stored in the memory 204. In implementations, the one or more processing units 202 may be implemented as one or more hardware processors including, for example, a microprocessor, an application-specific instruction-set processor, a graphics processing unit, a physics processing unit (PPU), a central processing unit (CPU), a graphics processing unit (GPU), a digital signal processor, etc. Additionally or alternatively, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

The memory 204 may include computer-readable media in a form of volatile memory, such as Random Access Memory (RAM) and/or non-volatile memory, such as read only memory (ROM) or flash RAM. The memory 204 is an example of computer-readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

Although in this example, only hardware components are described in the adaptive encoding coding system 104, in other instances, the adaptive encoding coding system 104 may further include other hardware components such as an encoder 212, a to-be-encoded frame buffer 214, a to-be-sent frame buffer 216, and/or other software components such as program units to execute instructions stored in the memory 204 for performing various operations such as encoding, compressions, transmission of video frames, etc.

### Example Adaptive Decoding System

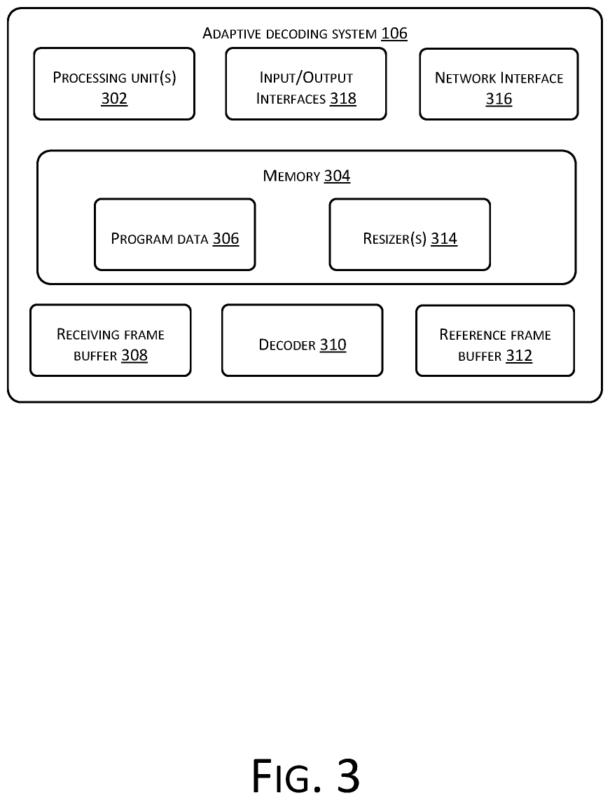

FIG. 3 illustrates the client device 112 that includes the adaptive decoding coding system 106 in more detail. In implementations, the adaptive decoding system 106 may include, but is not limited to, one or more processing units 302, memory 304, and program data 306. Additionally, the adaptive decoding system 106 may further include a receiving frame buffer 308, a decoder 310, a reference frame buffer 312, and one or more resizers 314. The receiving frame buffer 308 is configured to receive and store bit streams or encoded data representing one or more video frames that are to be decoded and are received from the client device 112, the one or more servers 110, and/or the adaptive encoding system 104. The reference frame buffer 308 is configured to store video frames that have been reconstructed by the decoder 310, and are used as reference frames for decoding subsequent video frames. In some implementations, the adaptive decoding system 106 may further include a network interface 316 and an input/output interface 318. Additionally or alternatively, some or all of the functionalities of the adaptive decoding system 106 may be implemented using an ASIC (i.e., Application-Specific Integrated Circuit), a FPGA (i.e., Field-Programmable Gate Array), or other hardware provided in the adaptive decoding system 106.

In implementations, the one or more processing units 302 are configured to execute instructions received from the network interface 316, received from the input/output interface 318, and/or stored in the memory 304. In implementations, the one or more processing units 302 may be implemented as one or more hardware processors including, for example, a microprocessor, an application-specific instruction-set processor, a graphics processing unit, a physics processing unit (PPU), a central processing unit (CPU), a graphics processing unit (GPU), a digital signal processor, etc. Additionally or alternatively, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

The memory 304 may include computer-readable media in a form of volatile memory, such as Random Access Memory (RAM) and/or non-volatile memory, such as read only memory (ROM) or flash RAM. The memory 304 is an example of computer-readable media as described in the foregoing description.

### Example Methods

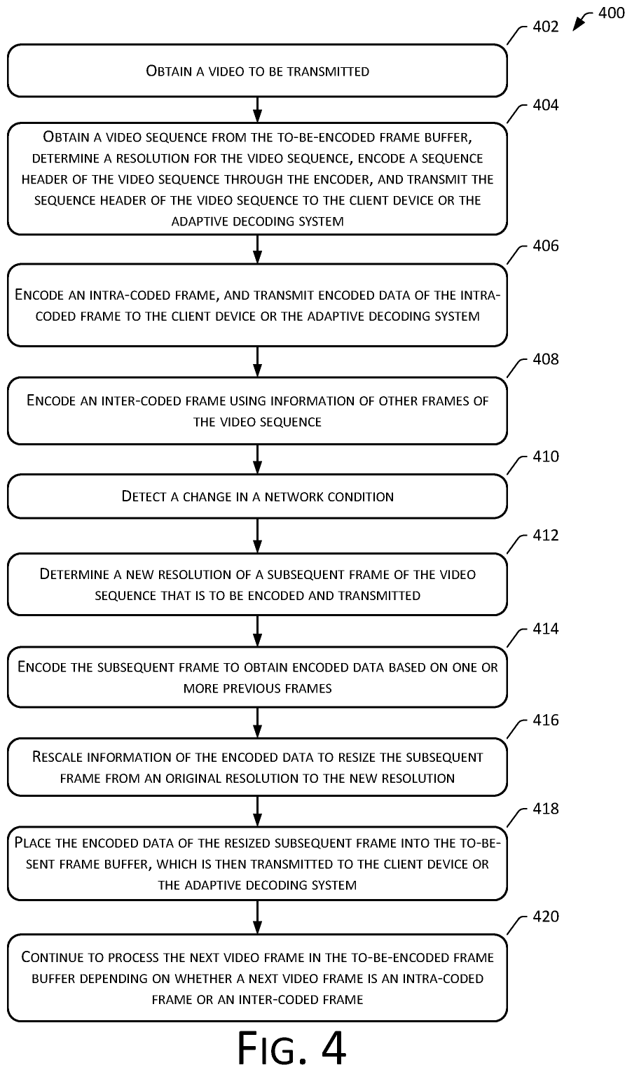

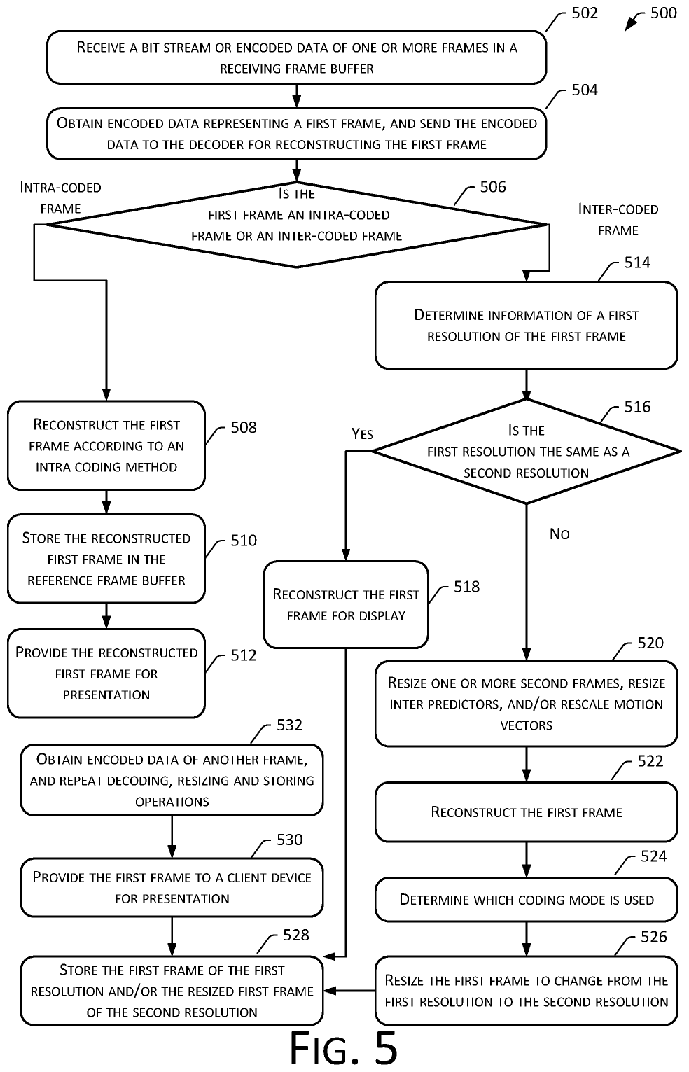

FIG. 4 is a schematic diagram depicting an example method of adaptive video encoding. FIG. 5 is a schematic diagram depicting an example method of adaptive video decoding. The methods of FIGS. 4 and 5 may, but need not, be implemented in the environment of FIG. 1 and using the systems of FIG. 2 and/or FIG. 3. For ease of explanation, methods 400 and 500 are described with reference to FIGS. 4 and 5. However, the methods 400 and 500 may alternatively be implemented in other environments and/or using other systems.

The methods 400 and 500 are described in the general context of computer-executable instructions. Generally, computer-executable instructions can include routines, programs, objects, components, data structures, procedures, modules, functions, and the like that perform particular functions or implement particular abstract data types. Furthermore, each of the example methods are illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 4, at block 402, the adaptive encoding system 104 may obtain a video to be transmitted. In implementations, the adaptive encoding system 104 may receive a request for a video directly from the client device 112, obtain the video from the one or more servers 110, for example, a video collection associated with the one or more servers 110 that includes the requested video, and place the requested video in the to-be-encoded frame buffer 214. In some implementations, the one or more servers 110 may receive the request for the video from the client device 112, obtain the requested video from the video collection, and place the requested video in the to-be-encoded frame buffer 214 of the adaptive encoding system 104. In implementations, the requested video may be divided into one or more video sequences with each video including a plurality of video frames for transmission.

At block 404, the adaptive encoding system 104 may obtain a video sequence from the to-be-encoded frame buffer 214, determine a resolution for the video sequence, encode a sequence header of the video sequence through the encoder 212, and transmit the sequence header of the video sequence to the client device 112 or the adaptive decoding system 106.

In implementations, the adaptive encoding system 104 may determine the resolution for the video sequence based on network conditions, such as network bandwidth, an amount of traffic, etc. In implementations, the determined resolution may be a maximal resolution for all video frames in the video sequence. In implementations, the sequence header may include, but is not limited to, information of the determined resolution, resizing (e.g., up-sampling or down-sampling) filter coefficients used for resizing the frames of the video sequence if resizing is needed, etc.

At block 406, the adaptive encoding system 104 may encode a video frame (e.g., an intra-coded frame) using image data of the video frame (only) without using image data of any other video frames of the video sequence, and transmit encoded data of the intra-coded frame, for example, to the client device 112 or the adaptive decoding system 106.

In implementations, the adaptive encoding system 104 may encode the intra-coded frame, for example, through the encoder 212 using a conventional intra coding method, and place encoded data of the intra-coded frame in the to-be-sent buffer 216, which is transmitted to the client device 112 or the adaptive decoding system 106.

At block 408, the adaptive encoding system 104 may encode a video frame (e.g., an inter-coded frame) using information (such as image data, motion vectors, etc.) of other frames of the video sequence.

In implementations, the adaptive encoding system 104 may encode the inter-coded frame through the encoder 212 using a conventional inter coding method.

At block 410, the adaptive encoding system 104 may detect a change in a network condition (e.g., a change in network bandwidth, or a change in an amount of traffic, etc.). For example, the adaptive encoding system 104 may detect that the network bandwidth is decreased or increased, or the amount of traffic is increased or decreased.

At block 412, in response to detecting the change, the adaptive encoding system 104 may determine a new resolution of a subsequent frame (e.g., another inter-coded frame) of the video sequence that is to be encoded and transmitted.

In implementations, if the network bandwidth is reduced, or the amount of traffic is increased, the adaptive encoding system 104 may determine that the resolution of the subsequent frame of the video sequence that is to be encoded and transmitted needs to be reduced, e.g., reduced to one of a plurality of predefined resolutions. Alternatively, if the network bandwidth is increased or the amount of traffic is decreased, the adaptive encoding system 104 may determine that the resolution of the subsequent frame of the video sequence that is to be encoded and transmitted needs to be increased, e.g., increased to one of the plurality of predefined resolutions and up to the maximal resolution indicated in the sequence header of the video sequence including the subsequent frame.

At block 414, the adaptive encoding system 104 may encode the subsequent frame (e.g., the other inter-coded frame) to obtain encoded data of the subsequent frame based on one or more previous frames through the encoder 212 using a conventional inter coding method. In implementations, the encoded data may include, but is not limited to, motion vectors, prediction errors, etc.

At block 416, the adaptive encoding system 104 may rescale information of the encoded data to resize (e.g., down-sample if the resolution is to be reduced, or up-sample if the resolution is to be increased) the subsequent frame from an original resolution to the new resolution.

In implementations, the adaptive encoding system 104 may rescale the motion vectors and predictors, for example, included in the encoded data according to a relationship between the original resolution of the subsequent frame and the new resolution. In implementations, the adaptive encoding system 104 may further include resizing (e.g., up-sampling or down-sampling) filter coefficients that are used for changing the resolution of the subsequent frame into a frame header of the subsequent frame or a data header of the encoded data. In this case, a filter used for resizing or sampling a previously encoded frame may be used as filter predictors, and a predictive coding may be applied when a filter for a current frame is encoded.

At block 418, the adaptive encoding system 104 may place the encoded data of the resized subsequent frame into the to-be-sent frame buffer 216, which is then transmitted to the client device 112 or the adaptive decoding system 106.

At block 420, depending on whether a next video frame is an intra-coded frame or an inter-coded frame, the adaptive encoding system 106 may continue to process the next video frame in the to-be-encoded frame buffer 214 according to operations of some of the above method blocks.

Although the above method blocks are described to be executed in a particular order, in some implementations, some or all of the method blocks can be executed in other orders, or in parallel. For example, the adaptive encoding system 104 may encode a current video frame using the encoder 212, while transmitting encoded data of a previous video frame placed in the to-be-sent frame buffer 216 to the client device 112 or the adaptive decoding system 106.

Referring to FIG. 5, at block 502, the adaptive decoding system 106 receive a bit stream or encoded data of one or more frames in the receiving frame buffer 308.

In implementations, the adaptive decoding system 106 may receive the bit stream or the encoded data of the one or more frames from the one or more servers 110 or the adaptive encoding system 104, and place the bit stream or the encoded data of the one or more frames in the receiving frame buffer 308. In some implementations, the client device 112 may receive the bit stream or the encoded data of the one or more frames from the one or more servers 110 or the adaptive encoding system 104 after the user's request for a video is sent to the one or more servers 110 or the adaptive encoding system 104, and place the bit stream or the encoded data of the one or more frames in the receiving frame buffer 308 of the adaptive decoding system 106.

At block 504, the adaptive decoding system 106 may obtain or fetch encoded data representing a first frame from the receiving frame buffer 308, and send the encoded data representing the first frame to the decoder 310 for decoding to reconstruct the first frame.

Depending on a type of the first frame, the encoded data representing the first frame may include, but is not limited to, encoded image data, motion vectors, and/or prediction errors. In implementations, encoded data representing the first frame may also include other related data such as header data, filtering data, etc. By way of example and not limitation, types of video frames may include a video frame that is encoded using image data of the video frame (only) without using image data of any other video frames that are before and/or after the video frame (e.g., an intra-coded frame), a video frame that is encoded using information (such as image data, motion vectors, etc.) of other frames that are before and/or after the video frame (e.g., an inter-coded frame).

At block 506, the adaptive decoding system 106 may determine whether the first frame is an intra-coded frame or an inter-coded frame based on a frame type indicated in the frame header of the first frame (or a data header of the encoded data representing the first frame).

At block 508, in response to determining that the first frame is an intra-coded frame, the adaptive decoding system 106 may decode the encoded data representing the first frame to reconstruct the first frame using the decoder 310 according to an intra coding method of a video codec used for the video sequence.

At block 510, the adaptive decoding system 106 may store the reconstructed first frame in the reference frame buffer 312 for use as a reference frame by subsequent video frames.

At block 512, the adaptive decoding system 106 may provide the reconstructed first frame to a display of the client device 112 for presentation to the user.

At block 514, in response to determining that the first frame is an inter-coded frame, the adaptive decoding system 106 may obtain or determine information of a first resolution of the first frame.

In implementations, the adaptive decoding system 106 may obtain or determine information of the first resolution of the first frame based on a relative resolution (e.g., a ratio, such as 1/2, 1/4, 1/2ₖ, or n/m, where k, n, and m are positive integers) signaled or indicated in a frame header of the first frame (or a data header of the encoded data representing the first frame) and a maximal resolution signaled or indicated in a sequence header of a video sequence including the first frame.

At block 516, the adaptive decoding system 106 may determine whether the first resolution of the first frame is the same as a second resolution (e.g., a resolution of one or more second frames that are used as reference frames for reconstructing the first frame).

In implementations, the one or more second frames are received prior to the first frame and are currently stored in the reference frame buffer 312. In implementations, depending on which coding mode that the adaptive decoding system 106 employs, the reference frame buffer 312 may include or store different types or resolutions of reference frames that are received by the adaptive decoding system 106 prior to receiving the encoded data of the first frames.

In implementations, the adaptive decoding system 106 may be configured with one or more of three different coding modes to support adaptive resolution change. According to a first coding mode, if a current video frame that is received and reconstructed has a different resolution (e.g., a lower resolution) than that of a previous video frame, the current video frame is always resized (e.g., up-sampled) so that the resized video frame has the same resolution of the previous video frame, and is stored in the reference frame buffer 312.

According to a second coding mode, a current video frame of an original resolution is directly stored in the reference frame buffer 312. Furthermore, if the original resolution of the current video frame is different from a resolution of a subsequent or future video frame and the current frame is used as a reference frame of any one of subsequent video frame(s) (e.g., the original resolution of the current video frame is lower than the resolution of the subsequent video frame), the current video frame is resized (e.g., up-sampled), and the resized video frame is also stored in the reference frame buffer 312. In implementations, if the second coding mode is used, the adaptive decoding system 106 may determine the resolution of the subsequent video frame, and resize the current video frame in response to determining that the original resolution of the current video frame is different from (e.g., lower than) the resolution of the subsequent video frame and the current frame is used as the reference frame of any one of subsequent video frame(s).

According to a third coding mode, a current video frame that is received and reconstructed is stored in the reference frame buffer 312 without resizing and storing the current video frame in the reference frame buffer, regarding of whether the current video frame has the same resolution as a previous video frame or not.

At block 518, in response to determining that the first resolution of the first frame is same as the second resolution (e.g., the resolution of the one or more second frames), the adaptive decoding system 106 may decode the encoded data representing the first frame using the decoder 310 based on at least some data of the one or more second frames to reconstruct the first frame.

In implementations, the at least some data of the one or more second frames may include, but is not limited to, inter predictors (or motion predictors), motion vectors, image data of the one or more second frames. For example, the adaptive decoding system 106 may resize the inter predictors and/or scale the motion vectors used in inter prediction of the one or more second frames, and decode the encoded data representing the first frame based on the resized predictors and/or the scaled motion vectors using the decoder 310. Additionally or alternatively, the adaptive decoding system 106 may decode the encoded data representing the first frame based on the image data of the one or more second frames. In some implementations, the adaptive decoding system 106 may decode the encoded data based on the resized predictors and/or the scaled motion vectors without using other data of the one or more second frames.

At block 520, in response to determining that the first resolution of the first is different from (e.g., lower than or higher than) the second resolution of the one or more second frames, the adaptive decoding system 106 may resize (up-sample or down-sample, for example) the one or more second frames using a first resizer of the one or more resizers 314 to change from the second resolution to the first resolution, resize inter predictors, and/or scale motion vectors associated with the one or more second frames.

At block 522, the adaptive decoding system 106 may decode the encoded data representing the first frame using the decoder 310 based on the one or more resized second frames and/or the scaled motion vectors to reconstruct the first frame. In implementations, the decoder 310 may employ conventional decoding and reconstruction methods for decoding and reconstructing the first frame based on the one or more resized second frames and/or the scaled motion vectors.

At block 524, the adaptive decoding system 106 may determine which coding mode is used.

As described in the foregoing description, the adaptive decoding system 106 may be configured with one or more of the three different coding modes to support adaptive resolution change. The adaptive decoding system 106 may then determine which coding mode is used currently for the first frame and/or the video sequence including the first frame. Alternatively, the adaptive decoding system 106 may be configured with one of the three different coding modes as a default coding mode. In this case, the adaptive decoding system 106 does not need to perform determination of which coding mode is used, i.e., block 524 can be skipped.

At block 526, depending on which coding mode that the adaptive decoding system 106 currently employs, the adaptive decoding system 106 may optionally resize the first frame of the first resolution to change from the first resolution to the second resolution of the one or more second frames using a second resizer of the one or more resizers 314.

In implementations, the sequence header of the video sequence and/or the frame header of the first frame may include resizing filter coefficients (e.g., up-sampling or down-sampling filter coefficients) used for resizing the first frame from an original resolution (e.g., the second resolution or the maximal resolution indicated in the sequence header of the video sequence) to the first resolution. In this case, the adaptive decoding system 106 may resize the first frame from the first resolution to the second resolution or the maximal resolution indicated in the sequence header of the video sequence based on the resizing filter coefficients.

At block 528, the adaptive decoding system 106 may store one or more of the first frame of the first resolution and the resized first frame of the second resolution into the reference frame buffer 312 based on the coding mode that the adaptive decoding system 106 employs.

In implementations, the adaptive decoding system 106 (always) stores the resized first frame of the second resolution into the reference frame buffer 312 if the first coding mode is used. In implementations, if the second coding mode is used, the adaptive decoding system 106 stores the first frame of the first resolution into the reference frame buffer 312, and stores the resized first frame if the first resolution of the first frame is different from (e.g., lower than) a resolution of a subsequent frame (i.e., a video frame that is received after the first frame) and the first frame is used as a reference frame of any one of subsequent video frame(s). In implementations, if the second coding mode is used, the adaptive decoding system 106 may determine whether the first resolution of the first frame is the same as the resolution of the subsequent frame when determining whether to resize the first frame and to store the resized first frame. Upon determining that the first resolution of the first frame is different from (e.g., lower than) the resolution of the subsequent frame and the first frame is used as a reference frame of any one of subsequent video frame(s), the adaptive decoding system 106 may resize the first frame and store the resized first frame into the reference frame buffer 312. In implementations, if the third coding mode is used, the adaptive decoding system 106 stores (only) the first frame of the first resolution into the reference frame buffer 312.

At block 530, the adaptive decoding system 106 may provide the first frame to the client device 112 for presentation in a display of the client device 112.

In implementations, if the first resolution of the first frame less than the maximal resolution indicated in the sequence header of the video sequence or less than a desired or default resolution of the display of the client device 112, the adaptive decoding system 106 may first resize the first frame from the first resolution to the maximal resolution or the desired or default resolution of the display of the client device 112 using a third resizer of the one or more resizers 314, and then provide the resized first frame to the display of the client device 112 for presentation to the user.

In implementations, the third resizer may or may not be different from the second resizer, i.e., may or may not use a resizing or sampling method that is different from that of the second resizer. For example, the third resizer may use a resizing or sampling method that is more complicated than that of the second resizer. In implementations, the second resizer may use simple, zero-phase separable down-sampling and/or up-sampling filters, and the third resizer may use a bilateral or more complicated filter to resize (e.g., up-sample) the reconstructed first frame to the maximal resolution, or a resolution that is default or designated by the display of the client device 112.

In implementations, at least a subset of resizing or sampling results produced by the second resizer in the reference frame buffer 312 may be shared with a display buffer associated with the third resizer. Specifically, some results of the second resizer and the third resizer may be the same, for example, due to similar sampling methods used by the second resizer and the third resizer. This facilitates efficient storage of results and speeds up sampling processes of the second resizer and the third resizer.

Alternatively, if the first resolution of the first frame is the same as the maximal resolution indicated in the sequence header of the video sequence or the desired (or default) resolution of the display of the client device 112, the adaptive decoding system 106 may then simply provide the first frame to the display of the client device 112 for presentation to the user.

At block 532, the adaptive decoding system 106 may obtain or fetch encoded data of another frame, e.g., a third frame, from the receiving frame buffer 308, and perform operations of the above method blocks (e.g., blocks 504-530) for the third frame accordingly.

Although the above method blocks are described to be executed in a particular order, in some implementations, some or all of the method blocks can be executed in other orders, or in parallel. By way of example and not limitation, the decoder 310 and the one or more resizers 314 may operate simultaneously. For example, the adaptive decoding system 106 may decode a video frame using the decoder 310, while fetching another video frame from the receiving frame buffer 308 and determining a type of the other video frame. For another example, the adaptive decoding system 106 may perform storing of a video frame that is reconstructed by the decoder 310, while providing another reconstructed video frame that is received prior thereto to the client device 112 for presentation to the user.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media.

Although implementations have been described in language specific to structural features and/or methodological acts, it is to be understood that the claims are not necessarily limited to the specific features or acts described. Rather, the specific features and acts are disclosed as exemplary forms of implementing the claimed subject matter. Additionally or alternatively, some or all of the operations may be implemented by one or more ASICS, FPGAs, or other hardware.

The present disclosure can be further understood using the following clauses.

Clause 1: A method implemented by one or more computing devices, the method comprising: receiving encoded data representing a first frame of a first resolution; decoding the encoded data to obtain the first frame; resizing the first frame from the first resolution to a second resolution; and storing the resized first frame of the second resolution in a reference frame buffer.

Clause 2: The method of Clause 1, wherein decoding the encoded data to obtain the first frame is based on a second frame of the second resolution that is stored locally in the reference frame buffer.

Clause 3: The method of Clause 2, wherein the second frame is a frame of a video sequence that is received immediately prior to the first frame.

Clause 4: The method of Clause 1, further comprising resizing the first frame for display.

Clause 5: The method of Clause 1, wherein decoding the encoded data to obtain the first frame is based on one or more motion prediction blocks with respect to a second frame that is received prior to the first frame.

Clause 6: The method of Clause 1, further comprising: receiving other encoded data representing a third frame of a third resolution; and decoding the other encoded data to obtain the third frame based at least on the resized first frame of the second resolution.

Clause 7: The method of Clause 1, further comprising obtaining information of the first resolution of the first frame based at least in part on a particular field in a header of the first frame.

Clause 8: The method of Clause 7, wherein obtaining the information of the first resolution of the first frame is further based on another field in a header of a video sequence including the first frame.

Clause 9: One or more computer readable media storing executable instructions that, when executed by one or more processors, cause the one or more processors to perform acts comprising: receiving encoded data representing a first frame over a network; decoding the encoded data to obtain the first frame; storing the first frame of the first resolution in a reference frame buffer; determining whether a first resolution of the first frame is lower than a second resolution; and adaptively resizing the first frame from the first resolution to the second resolution and storing the resized first frame of the second resolution into the reference frame buffer in response to determining that the first resolution is not equal to the second resolution.

Clause 10: The one or more computer readable media of Clause 9, wherein decoding the encoded data to obtain the first frame is based on one or more motion prediction blocks with respect to a second frame that is received prior to the first frame.

Clause 11: The one or more computer readable media of Clause 9, the acts further comprising resizing the first frame for display.

Clause 12: The one or more computer readable media of Clause 9, the acts further comprising: receiving other encoded data representing a third frame of a third resolution; and decoding the other encoded data to obtain the third frame using one of the resized first frame of the second resolution or the first frame of the first resolution.

Clause 13: The one or more computer readable media of Clause 9, the acts further comprising obtaining information of the first resolution of the first frame based at least in part on a particular field in a header of the first frame.

Clause 14: The one or more computer readable media of Clause 13, wherein obtaining the information of the first resolution of the first frame is further based on another field in a header of a video sequence including the first frame.

Clause 15: A system comprising: one or more processors; memory storing executable instructions that, when executed by the one or more processors, cause the one or more processors to perform acts comprising: receiving encoded data representing a first frame of a first resolution; determining whether the first resolution of the first frame is equal to a second resolution of a second frame; resizing predictors and/or rescaling motion vectors associated with the second frame in response to the first resolution of the first frame is not equal to the second resolution of the second frame; decoding the encoded data to obtain the first frame based at least in part on the resized predictors and/or the rescaled motion vectors; and storing the first frame of the first resolution into a reference frame buffer.

Clause 16: The system of Clause 15, wherein the acts further comprise resizing the first frame for display.

Clause 17: The system of Clause 15, wherein the first frame is received remotely over a network, and the second frame is stored locally in the reference frame buffer.

Clause 18: The system of Clause 15, wherein the acts further comprise: receiving other encoded data representing a third frame of a third resolution; and decoding the other encoded data to obtain the third frame based at least in part on the first frame.

Clause 19: The system of Clause 15, wherein the acts further comprise obtaining information of the first resolution of the first frame based at least in part on a particular field in a header of the first frame.

Clause 20: The system of Clause 19, wherein obtaining the information of the first resolution of the first frame is further based on another field in a header of a video sequence including the first frame.

What is claimed is:

1. A method implemented by one or more computing devices, the method comprising:
receiving encoded data representing a first frame of a first resolution;
decoding the encoded data to obtain the first frame;
resizing the first frame from the first resolution to a second resolution; and
storing the resized first frame of the second resolution in a reference frame buffer.

2. The method of claim 1, wherein decoding the encoded data to obtain the first frame is based on a second frame of the second resolution that is stored locally in the reference frame buffer.

3. The method of claim 2, wherein the second frame is a frame of a video sequence that is received immediately prior to the first frame.

4. The method of claim 1, further comprising resizing the first frame for display.

5. The method of claim 1, wherein decoding the encoded data to obtain the first frame is based on one or more motion prediction blocks with respect to a second frame that is received prior to the first frame.

6. The method of claim 1, further comprising:
receiving other encoded data representing a third frame of a third resolution; and
decoding the other encoded data to obtain the third frame based at least on the resized first frame of the second resolution.

7. The method of claim 1, further comprising obtaining information of the first resolution of the first frame based at least in part on a particular field in a header of the first frame.

8. The method of claim 7, wherein obtaining the information of the first resolution of the first frame is further based on another field in a header of a video sequence including the first frame.

9. One or more computer readable media storing executable instructions that, when executed by one or more processors, cause the one or more processors to perform acts comprising:
receiving encoded data representing a first frame;
decoding the encoded data to obtain the first frame;
storing the first frame of the first resolution in a reference frame buffer;
determining whether a first resolution of the first frame is equal to a second resolution; and
adaptively resizing the first frame from the first resolution to the second resolution and storing the resized first frame of the second resolution into the reference frame buffer in response to determining that the first resolution is not equal to the second resolution.

10. The one or more computer readable media of claim 9, wherein decoding the encoded data to obtain the first frame is based on one or more motion prediction blocks with respect to a second frame that is received prior to the first frame.

11. The one or more computer readable media of claim 9, the acts further comprising resizing the first frame for display.

12. The one or more computer readable media of claim 9, the acts further comprising:
receiving other encoded data representing a third frame of a third resolution; and
decoding the other encoded data to obtain the third frame using one of the resized first frame of the second resolution or the first frame of the first resolution.

13. The one or more computer readable media of claim 9, the acts further comprising obtaining information of the first resolution of the first frame based at least in part on a particular field in a header of the first frame.

14. The one or more computer readable media of claim 13, wherein obtaining the information of the first resolution of the first frame is further based on another field in a header of a video sequence including the first frame.

15. A system comprising:
one or more processors;
memory storing executable instructions that, when executed by the one or more processors, cause the one or more processors to perform acts comprising:
receiving encoded data representing a first frame of a first resolution;
determining whether the first resolution of the first frame is equal to a second resolution of a second frame;
resizing predictors and/or rescaling motion vectors associated with the second frame in response to the first resolution of the first frame is not equal to the second resolution of the second frame;
decoding the encoded data to obtain the first frame based at least in part on the resized predictors and/or the rescaled motion vectors; and
storing the first frame of the first resolution into a reference frame buffer.

16. The system of claim 15, wherein the acts further comprise resizing the first frame for display.

17. The system of claim 15, wherein the first frame is received remotely over a network, and the second frame is stored locally in the reference frame buffer.

18. The system of claim 15, wherein the acts further comprise:
receiving other encoded data representing a third frame of a third resolution; and
decoding the other encoded data to obtain the third frame based at least in part on the first frame.

19. The system of claim 15, wherein the acts further comprise obtaining information of the first resolution of the first frame based at least in part on a particular field in a header of the first frame.

20. The system of claim 19, wherein obtaining the information of the first resolution of the first frame is further based on another field in a header of a video sequence including the first frame.
